(19) United States
(12) Patent Application Publication
(10) Pub. No.: US 2015/0265102 A1
(43) Pub. Date: Sep. 24, 2015

(54) MOUNTABLE BLENDER SYSTEM AND CONTAINER FOR UPSIDE DOWN BLENDING

(71) Applicant: VITA-MIX CORPORATION, Olmsted Township, OH (US)

(72) Inventors: James Edward Kidd, Willoughby, OH (US); David J. Kolar, Stow, OH (US)

(21) Appl. No.: 14/663,742

(22) Filed: Mar. 20, 2015

Related U.S. Application Data
(60) Provisional application No. 61/968,099, filed on Mar. 20, 2014.

(51) Int. Cl. A47J 43/044

(52) U.S. Cl. CPC A47J 43/044; A47J 2043/04454

(57) ABSTRACT

A blender system is configured to mount to an object. The blender system includes a mounting bracket that couples the blender system to an underneath side of a cabinet or a counter. The blender system may include a housing assembly and a blending container. The blending container selectively couples the housing assembly at an interlock, and the housing assembly includes a motor for rotating an axial shaft of the blender system that includes a mixing blade for blending items in the blending container. In some examples, the blender system includes a quick release agitator for separating the axial shaft and the mixing blade from the motor. In other examples, the interlock includes at least one of a rotating locking tab assembly and a magnetic interlock.

### CROSS-REFERENCE TO RELATED APPLICATIONS

This application claims priority to U.S. Provisional Application Serial No. 61/968,099, filed on Mar. 20, 2014, entitled “UNDER COUNTER OR UNDER CABINET BLENDER AND CONTAINER FOR UPSIDE DOWN BLENDING”, the entirety of which is incorporated herein by reference.

### FIELD

This disclosure relates to a blender system. More particularly, the disclosure relates to a mountable blender system and container for upside down blending.

### BACKGROUND

Traditional blenders are generally located in one of two locations, either on a countertop or in a cabinet. When placed on a countertop, a user has easy access to the blender; however, the blender takes up space on the countertop. This arrangement can clutter a kitchen or other area as well as occupy valuable space on a work surface which could otherwise be used for other purposes. On the other hand, when placed in a cabinet, the blender does not take up space on the countertop; as a result, however, a user no longer has easy access to the blender. In fact, in order to properly use a blender stored in a cabinet, the user must remove the blender from the cabinet and place the blender on the countertop. As such, traditional blenders suffer from the drawback that they either take up space on a countertop—in which case they are easily accessible; or they are not easily accessible—in which case they are stored in a cabinet and do not take up space on a countertop.

### SUMMARY

The following presents a simplified summary of the disclosure in order to provide a basic understanding of some example aspects described in the detailed description. A blender system is configured to mount to an object. The blender system includes a mounting bracket that may couple the blender system to an underneath side of a cabinet or counter. The blender system may include a housing assembly and a blending container. The blending container selectively couples the housing assembly at an interlock, and the housing assembly includes a motor for rotating an axial shaft of the blender system. The blender system may include a blade assembly coupled to the axial shaft for blending of foodstuffs in the blending container. The blending container can include a recess formed at a bottom portion thereof for accepting a shaft protrusion formed at an end of the axial shaft. In some examples, the blender system includes a quick release agitator for separating the axial shaft and the blade assembly from the motor. In an aspect, the interlock includes at least one of a rotating locking tab assembly and a magnetic interlock for selectively coupling the blending container to the housing assembly.

### BRIEF DESCRIPTION OF THE DRAWING FIGURES

The above and other features, aspects and advantages of the present invention are better understood when the following detailed description of the invention is read with reference to the accompanying drawings, in which:

FIG. 1 is an illustration of a blender system according to various disclosed aspects;

FIG. 2 is an illustration of a blender according to various disclosed aspects; and

FIG. 3 is an illustration of a cross section of a blender system according to various disclosed aspects.

### DETAILED DESCRIPTION

The following presents a description of the disclosure; however, aspects may be embodied in many different forms and should not be construed as limited to the embodiments set forth herein. Furthermore, the following examples may be provided alone or in combination with one or any combination of the examples discussed herein.

It is noted that the various embodiments described herein may include other components and/or functionality. It is further noted that while various embodiments refer to a blender or a blender system, various other systems may be utilized in view of embodiments described herein. For example, embodiments may be utilized in food processor systems, spice grinder systems, coffee grinder systems, mixing systems, hand-held blending systems, various other food preparation systems, and the likes. As such, references to a blender, blender system, and the like, are understood to include food processor systems, and other mixing systems that blend, mix, agitate, or otherwise process foodstuff. Such systems generally include a blender base that may include a motor, a blade assembly, and a controller. Further, such systems may include a container, a display, a memory or a processor. A blade assembly, a blending container, and a blender base may removably or irremovably attach. The blending container may be powered in any appropriate manner, such as disclosed in U.S. patent application Ser. No. 14/213,557, entitled Powered Blending Container, which is hereby incorporated by reference. Foodstuff may be added to the blending container. Furthermore, while blending of “ingredients,” “contents,” or “foodstuffs” is described by various embodiments, it is noted that non-food stuff may be mixed or blended, such as paints, epoxies, construction material (e.g., mortar, cement, etc.), and the like.

It is noted that the blending systems may include any household blender and/or any type of commercial blending system, including those with covers that may encapsulate or partially encapsulate the blender. Commercial blending systems may include an overall blending system, such as a modular blending system that may include the blender along with other components, such as a cleaner, foodstuff storage device (including a refrigerator), an ice maker and/or dispenser, a foodstuff dispenser (a liquid or powder flavoring dispenser) or any other combination of such.

Moreover, blending of foodstuff or ingredients may result in a blended product. Such blended products may include drinks, frozen drinks, smoothies, shakes, soups, purees, sorbets, butter (nut), dips or the likes. It is noted that various other blended products may result from blending ingredients. Accordingly, terms such as “blended product” or “drink” may be used interchangeably unless context suggests otherwise or warrants a particular distinction among such terms. Further, such terms are not intended to limit possible blended products and should be viewed as examples of possible blended products.

Furthermore, while a counter or cabinet is described, it is noted that the described blender systems may be utilized in various other environments and/or in conjunction with various other objects. For instance, a blender system may be disposed at an underside of various articles of furniture (e.g., desk, table, etc.), fixtures, building structures, appliances and/or the like.

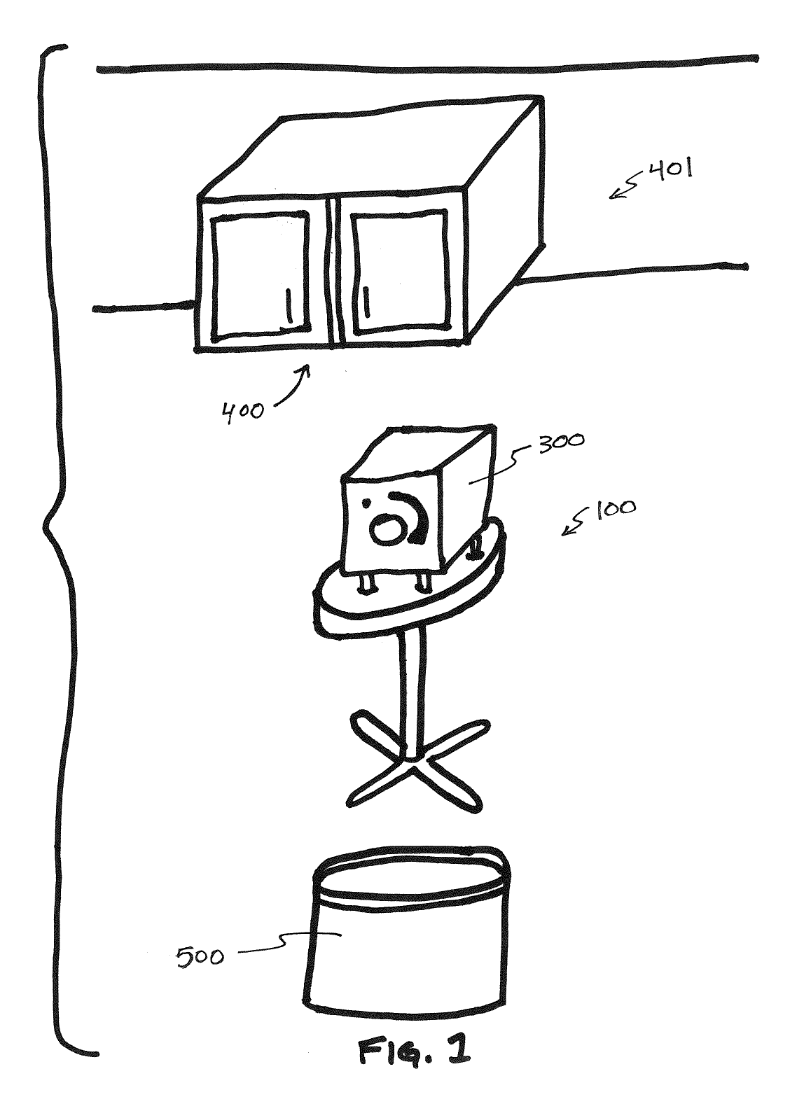

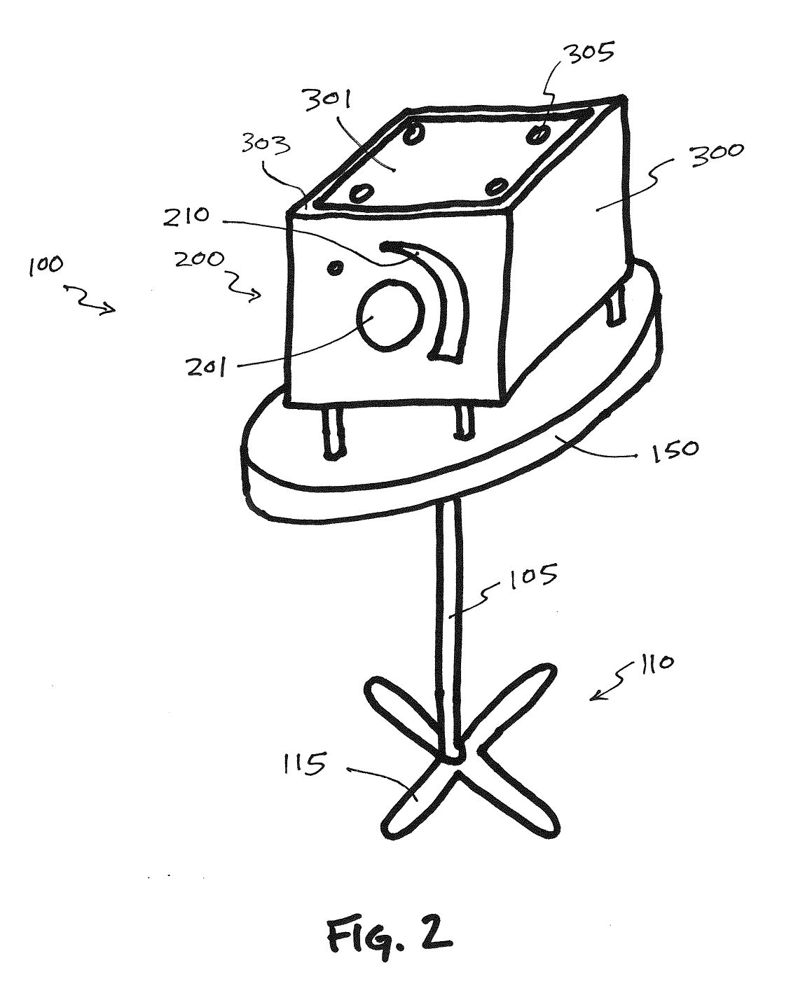

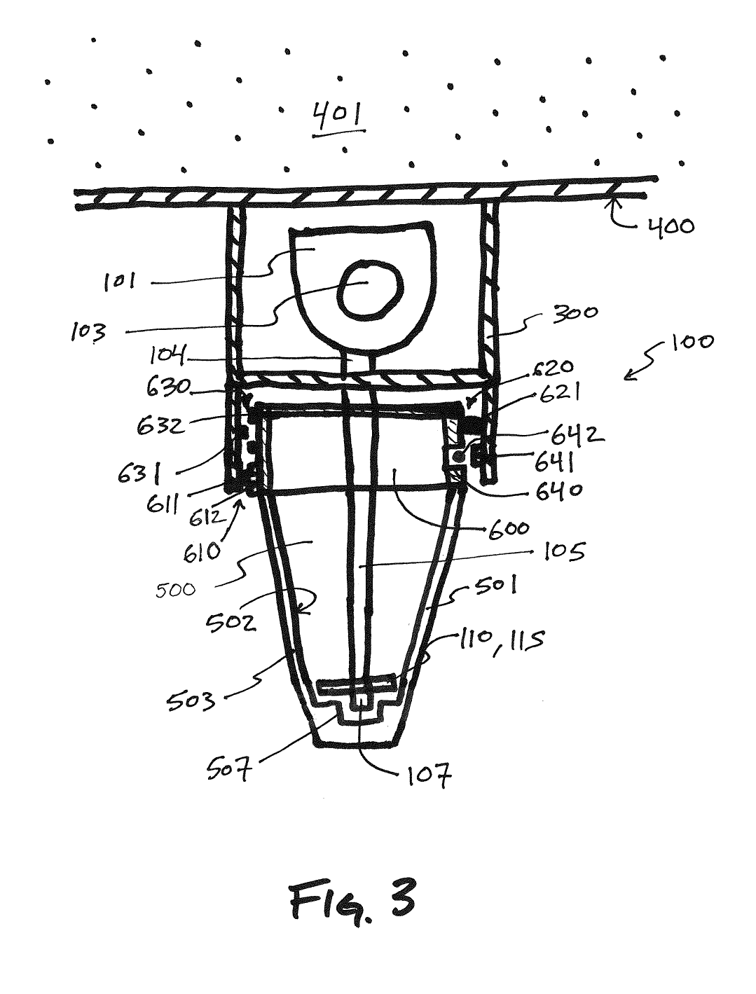

As shown in FIG. 1, the present disclosure relates to an under counter or under cabinet blender system 100 having a housing assembly 300 and a blending container 500 (which may include a container having a general cup shape, pitcher shape, bowl shape or the like) for upside down blending. The blender system 100 is configured to mount to an underneath side 400 of a counter or cabinet 401. In an example embodiment of the disclosure, shown in FIG. 2 and FIG. 3, the blender system 100 comprises a motor 101, driveline 103, and controls 200. In one example, the motor 101 operates to rotate the driveline 103, including a primary drive shaft 104. The primary drive shaft 104 is configured to rotate a spindle or axial shaft 105 of the blender system 100 to blend items. The axial shaft 105 can include a motor drive coupling (not shown) configured to couple the primary drive shaft 104 of the motor 101 to the axial shaft 105 of the blender system 100. The axial shaft 105 can further include and/or be coupled with a blade assembly 110 for blending. The blade assembly 110 can include a plurality of radially extending blades 115 configured to blend food or other items to be blended in the blending container 500. As shown in FIG. 2, the blender system 100 can include controls 200 for mechanically or electrically controlling or operating the blender system 100, such as, an on/off button, switch, or knob 201 as well as a speed control 210 for adjusting the speed at which the blade assembly 110 rotates.

As depicted in FIG. 2, the housing assembly 300, which houses the motor (101 in FIG. 3 but not shown in FIG. 2), comprises a mounting bracket 301. For instance, the mounting bracket 301 can be arranged at a top portion 303 of the housing assembly 300. The mounting bracket 301 is configured to mount to an under side or underneath side 400 of the cabinet or countertop 401. In particular, the mounting bracket 301 can comprise mounting hardware 305, such as screws, clips, or other fasteners configured to attach the mounting bracket 301 to the underneath side 400 of the cabinet or counter 401. In another example, the mounting bracket 301 can fixedly or removably couple to the housing assembly 300 such that the blender system 100 can be selectively installed on the mounting bracket 301 attached to the underneath side 400 of the cabinet or counter 401.

In an exemplary embodiment, shown in FIG. 2, the blender system 100 can include a quick release agitator 150 configured to engage and/or disengage the axial shaft 105 including the blade assembly 110 from the housing assembly 300 (and consequently, the motor 101 in FIG. 3). For example, when the quick release agitator 150 is engaged, the motor 101 operates to rotate the axial shaft 105 including the blade assembly 110. On the other hand, when the quick release agitator 150 is disengaged, the axial shaft 105 including the blade assembly 110 can be separated from the housing assembly 300 and the motor 101. For instance, the quick release agitator 150 can be separated from the housing assembly 300 and the motor 101 when the blender system 100 is not in use, such that the blender system 100 does not pose a safety risk by having an exposed blade assembly 110 extending from the housing assembly 300. In at least one embodiment, the quick release agitator 150 can be entirely separated from the housing assembly 300 and/or the motor 101 such that the axial shaft 105 including the blade assembly 110 can be cleaned or washed.

As shown in FIG. 1 and FIG. 3, the under counter or under cabinet blender system 100 can comprise a pitcher or blending container 500 for receiving and holding the items to be blended, therein. In one example, shown in FIG. 3, the blending container 500 can comprise a recess 507 for accepting a shaft protrusion 107 formed on an end portion of the axial shaft 105. The shaft protrusion 107 can substantially sit within the recess 507 formed in, for example, a bottom portion of the blending container 500 to, for example, stabilize the axial shaft 105 while the motor 101 is operating to rotate the axial shaft 105. In one example, the recess 507 can fixedly couple the shaft protrusion 107 such that the axial shaft 105 and/or the blade assembly 110 are fixedly installed within the blending container 500. The blade assembly 110 and/or axial shaft 105 can be removed from the blending container 500 to allow, for example, cleaning thereof. In another example, the recess 507 can be formed in the blending container 500 and accept the shaft protrusion 107 when the blending container 500 is attached to the housing assembly 300 and the axial shaft 105 and/or blade assembly 110 are inserted into the blending container 500.

It is noted that embodiments may comprise other configurations of blender system 100 not shown for sake of brevity. For instance, axial shaft 105 may be coupled (e.g., removably or irremovably) to the blending container 500. Axial shaft 105 and blending container 500 may be releasably attached to housing assembly 300, such as through threaded portions, screws, latches, channel locks, or other fastening devices.

In another example, shown in FIG. 1 and FIG. 3, the blending container 500 may include a substantially cylindrical, conical, or other shaped container in which the axial shaft 105 including the blade assembly 110 can be inserted. For instance, the blending container 500 can be selectively attached to the housing assembly 300. When attached, the blending container 500 conceals the axial shaft 105 and blade assembly 110. When detached, the blending container 500 is separated from the blender system 100, and the axial shaft 105 and blade assembly 110 are exposed, as shown in FIG. 1 and FIG. 2. For instance, the user can load the blending container 500 with the items to be blended and then attach the blending container 500 to the housing assembly such that the axial shaft 105 and blade assembly 110 are inserted into the blending container 500. Once the blender system 100 is operated to blend the items, the blending container 500 can be removed from the housing assembly 300 and the blended items can be, for example, emptied from the blending container 500.

In another example, shown in FIG. 1 and FIG. 3, the blending container 500 can comprise a blending container 500, such as a substantially cylindrical, conical, or other shaped container which includes the blade assembly 110 and/or the axial shaft 105. For instance, the blending container 500 can be selectively attached to the housing assembly 300. When attached, the blending container 500 conceals the axial shaft 105 and blade assembly 110 and connects the axial shaft 105 and blade assembly 110 to the motor 101. When detached, the blending container 500, including the axial shaft 105 and/or blade assembly 110 concealed therein, are separated from the blender system 100. The blending container 500, when attached to and/or when removed from the housing assembly 300, can shield the exposed blade assembly 110 and prevent blended items from dripping or otherwise falling from the blade assembly 110 onto, for example, a countertop. For instance, the user can assemble the blade assembly 110 and/or axial shaft 105 into the blending container 500, load the items to be blended into the blending container 500, and then attach the blending container 500 to the housing assembly 300. Once the blender system 100 is operated to blend the items, the blending container 500, including the blade assembly 110 and/or axial shaft 105 can be removed from the housing assembly 300 and the blended items can be, for example, emptied from the blending container 500.

In still another example, the blending container 500 can comprise a “blend in cup”. The a blend in cup can serve as the container to receive and hold the items to be blended therein, can be configured to attach to the blender system 100, and can also serve as the container from which the blended items can be directly consumed or served, when removed from the blender system 100. For instance, the blending container 500 may include a single serving container.

In an example, as shown in FIG. 3, the blending container 500 can comprise insulation 501 to provide a reduction in thermal transfer between, for example, contents inside the cup and the surrounding environment as well as to dampen noise generated inside the cup when the blender system 100 is in use. In one example, the insulation 501 can comprise an insulation material, such as a solid, liquid, or gaseous medium. In another example, the insulation 501 can comprise a vacuum chamber formed between an inner wall 502 and an outer wall 503 of the blending container 500.

In yet another exemplary embodiment, the blending container 500 can comprise an interlock 600 for attaching the blending container 500 to the housing assembly 300. The interlock 600 can include a mechanical interlock, magnetic interlock, electronic interlock, or the like. In an aspect, the interlock 600 may include threadable engagement 610, such as mating threads 611, 612, wherein the blending container 500 can removably screw or thread on to and off of the housing assembly 300. The interlock 600 can include a rotating locking tab assembly 630 that permits engagement and/or disengagement of the blending container 500 with the housing assembly 300, such that the blending container 500 can be selectively coupled to the housing assembly 300 by rotating the blending container 500 with respect to an axis of the blender. When rotated, primary locking tabs 631 formed on the housing assembly 300 engage mating locking tabs 632 formed on the blending container 500. The primary locking tabs 631 and the mating locking tabs 632 can extend entirely and/or partially around a circumference of the blending container 500.

In at least one embodiment, the interlock 600 may include an arm (not shown) or attachment member that may extend from the housing assembly 300. An attachment member may include a support (e.g., plastic support, etc.) that may be foldable. The support may fold when not in use and unfold for use. In another example, the interlock may include straps (e.g., Velcro, rubber, fabric, etc.), latches, or the like.

In another example, the interlock 600 can comprise a magnetic interlock 620 comprising a magnet 621. The magnetic interlock 620 can, for example, magnetically couple the blending container 500 to the housing assembly 300, such that the blending container 500 can be selectively attached to the housing assembly 300 by way of the magnet 621 bonding the blending container 500 and the housing assembly 300 together. The blending container 500 can be removed from the housing assembly 300 by breaking the magnetic bond of the magnet 621. In another example, the interlock 600 can comprise lugs 640. The lugs 640 can comprise mating engagements to couple the blending container 500 to the housing assembly 300. In another example, the lugs 640 can encapsulate a pair of magnets comprising opposite polarity, such that a first magnet 641 provides a magnetic bond to couple a second magnet 642. As shown, the first magnet 641 can be arranged on a lug 640 formed on the housing assembly 300 and configured to magnetically bond with a second magnet 642 arranged on a mating lug 640 formed on the blending container 500.

The interlock 600, therefore, provides a positive mechanical locking of the blending container 500 to the housing assembly 300, such that the blending container 500 can be selectively attached to the housing assembly 300 while operating the blender system 100 and removed from the housing assembly 300 after operating the blender system 100. Accordingly, the under counter or under cabinet blender system 100 and blending container 500 for upside down blending of the instant disclosure provide a blender that is always easily accessible to the user and that frees up space on the countertop.

It is noted that the mounting bracket 301 may be disposed on another side of the housing assembly 300. For instance, the mounting bracket 301 may attach to a left, right, or back side of the housing assembly 300, as depicted in FIG. 2. For example, the mounting bracket 301 may be attachable to a side or back wall of the housing assembly 300 such that the blender system 100 may be attached to a door (e.g., a cabinet door), a wall, an appliance (e.g., refrigerator), or the like. In an aspect, the blender system 100 may be configured to allow a user to select a side of the housing assembly 300 (e.g., top, back, left, right, etc.) for attachment. It is noted that the mounting bracket 301 may be disposed on one or more sides. For instance, the mounting bracket 301 may attach to a corner of housing assembly 300. Such an arrangement may allow the blender system 100 to attach to a corner of an environment. In at least one example, a corner attachment may allow for increased stability of the blender system 100.

In an example, the blender system 100 may allow for the housing assembly 300 to attach to various objects or surfaces such that the blending container 500 may be attached to an underside of the housing assembly 300 and a user may utilize the controls 200. In at least one embodiment, the housing assembly 300 may not include controls disposed therein. For example, the blender system 100 may include a remote controller that can communicate with the housing assembly 300.

It is further noted that the mounting bracket 301 may include hooks, latches, or the like that allow for mounting and unmounting of the housing assembly 300 from the mounting bracket 301. For example, the mounting bracket 301 may be fixedly attached to a cabinet (e.g., via screws, bolts, etc.). A user may selectively attach the housing assembly 300 to the mounting bracket 301. Such may allow for storage of the housing assembly 300, cleaning of the blender system 100, or the like.

It will be apparent to those skilled in the art that various modifications and variations can be made without departing from the spirit and scope of the claimed invention.

What is claimed is:

1. A blender system configured to mount on a surface of an object, comprising:
a housing assembly comprising a motor configured to blend contents underneath; and
a mounting bracket coupled to the housing assembly and configured to attach the housing assembly to the underneath side of the object.

2. The blender system of claim 1, further comprising a blending container, wherein the blending container is configured to couple to the housing assembly at an interlock.

3. The blender system of claim 1, further comprising:
an axial shaft coupled to the motor, wherein the motor rotates the axial shaft; and
a blade assembly coupled to the axial shaft.

4. The blender system of claim 3, wherein the axial shaft is removably connected to the motor.

5. The blender system of claim 3, wherein the axial shaft is fixedly connected to the motor.

6. The blender system of claim 3, further comprising a blending container, wherein the blending container comprises a recess formed at a bottom portion thereof for accepting a shaft protrusion formed at an end of the axial shaft.

7. The blender system of claim 6, wherein the shaft protrusion sits within the recess for stabilizing the axial shaft.

8. The blender system of claim 7, wherein the recess fixedly couples the shaft protrusion such that the axial shaft is fixedly installed within the blending container.

9. The blender system of claim 7, wherein the recess selectively couples the shaft protrusion such that the axial shaft and the blade assembly are removably installed within the blending container.

10. The blender system of claim 3, further comprising a quick release agitator configured to separate the axial shaft from the motor.

11. The blender system of claim 2, wherein the interlock comprises a rotating locking tab assembly for selectively coupling the blending container to the housing assembly.

12. The blender system of claim 2, wherein the interlock comprises a magnetic interlock comprising a magnet, wherein the magnetic interlock selectively couples the blending container to the housing assembly.

13. The blender system of claim 12, wherein the magnetic interlock comprises at least one lug for encapsulating the magnet.

14. The blender system of claim 13, wherein a first magnet is arranged on the housing assembly in a first lug of the at least one lug and a second magnet is arranged on the blending container in a second lug of the at least one lug, and wherein the first magnet comprises a polarity opposite a polarity of the second magnet, such that the first magnet bonds with the second magnet to selectively couple the housing assembly and the blending container together.

15. A blending system for blending foodstuff, the blending system comprising:
a housing assembly comprising a motor configured to rotate a blade assembly;
a mounting bracket configured to attach to a first side of the housing assembly, wherein the mounting bracket is further configured to attach to a surface of an object; and
a blending container attachable to a bottom side of the housing assembly.

16. The blending system of claim 15, wherein a second side of the blending system comprises controls.

17. The blending system of claim 15, wherein the first side is a right side of the housing assembly.

18. The blending system of claim 15, wherein the first side is a left side of the housing assembly.

19. The blending system of claim 15, wherein the first side is a back side of the housing assembly.

20. The blending system of claim 15, wherein the first side is a top side of the housing assembly.
